(19) United States
(12) Patent Application Publication
(10) Pub. No.: US 2015/0248877 A1
(43) Pub. Date: Sep. 3, 2015

(54) Precision safety hoop for drum

(71) Applicant: Drum Workshop, Inc., Oxnard, CA (US)

(72) Inventor: John J. Good, Thousand Oaks, CA (US)

(73) Assignee: DRUM WORKSHOP, INC.

(21) Appl. No.: 13/694,519

(22) Filed: Dec. 10, 2012

Related U.S. Application Data
(63) Continuation-in-part of application No. 13/317,810, filed on Oct. 28, 2011, now Pat. No. 8,563,841.

(51) Int. Cl. G10D 13/02; B21D 53/16

(52) U.S. Cl. CPC G10D 13/023; B21D 53/16

(57) ABSTRACT

The method of drum structure formation that includes forming a strip of metal having an elongated edge into a counter hoop to be supported by a drum shell proximate the drum head, and having a hoop shaped edge area formed to resist or prevent drum stick damage, the forming including forming a reduced thickness strip bend proximate the hoop edge area.

This application is a continuation-in-part of pending U.S. application Ser. No. 13/317,810, filed Oct. 28, 2011.

### BACKGROUND OF THE INVENTION

This invention relates generally to the construction of drums, where drum sticks are used to strike hoops on the drums. More particularly, it concerns methods of construction of such hoops to avoid problems arising in their use.

In the past, the configurations of drum hoops led to problems of hoop distortion during their bend-formation, and of drainage from under the hoops, and also to problems of interference with drums sticks, as during impact (rim shots). Such impact with hoop edges can cause severe damage to drum sticks. Also, water and other particles tended to accumulate under hoops. There is need for structural changes overcoming these and other problems and disadvantages.

Problems relating to distortion of such hoops during their construction and assembly, led to inaccuracy and difficulty in drum tuning.

### SUMMARY OF THE INVENTION

It is a major object of the invention to provide solutions to the above problems. Basically, the invention is embodied in drum structure formation, characterized by forming a strip of metal into a counter hoop to be supported by a drum shell proximate the drum head, and having a hoop shaped edge area formed to provide distortion free hoop structure and to resist or prevent drum stick damage, said forming including forming a reduced thickness bend proximate said edge area.

As will be seen, a gap is formed and located between the edge and the hoop side wall, the reduced thickness bend located at or near a hoop rolled outer surface spaced from the gap. The forming of reduced thickness is effected prior to forming of the strip of metal into hoop shape, and prior to forming of the bend, whereby resistance to hoop bending, and distortion, are reduced. Reduced thickness formation is effected by milling one side of the metal strip portion to be rolled.

Another object is to provide the rolled configuration extending toward the outer side of the hoop, for gap concealment.

Further objects include provision of a hoop flange to be spaced from and in offset relation to the reduced thickness area, and provision of sideward projections integral with the hoop, and spaced from the rolled edge, the projections defining openings for drum tensioning rods.

An advantage to a top rolled hoop of reduced thickness is that it enables distortion free hoop bending, and leaves a smooth rounded surface for the drummer to strike the drumstick, on and without causing damage to the stick. The standard drum counter hoop has a straight edge or just a slight radius that causes severe damage to the stick as it is struck. Another advantage is strength, provided by rolling the top edge of the hoop, which increases strength and distortion free stability of the hoop. A further advantage is provision of a hoop edge that is flat upon hoop bending. With the rolled edge adding strength, the hoop will tend to stay in such flat condition, even under high tension.

Yet another object is to provide a drum shell having a reduced thickness edge rolled toward the outer side of the hoop, reducing hoop distortion.

An important object is to provide a method of drum structure distortion free formation, that includes the following steps:

a) provide flat elongated strip of metal,

b) locally mill a side portion of strip to provide reduced thickness along an edge portion of strip,

c) deform the elongated strip to provide sideward tuning projections spaced from the reduced thickness ledge portion of strip, and also to form a seating edge for engagement with a drum head annular rim,

d) roll the reduced thickness edge portion of the elongated strip to thereby form an elongated drum stick engaged rolled edge portion, or bend, such thickness reduction characterized as sufficient to prevent distortion of the hoop, out of annularity and to prevent distortion of said tuning projections during said rolling, and hoop bending.

e) bend the thus formed metal strip into hoop shape.

These and other objects and advantages of the invention, as well as the details of an illustrative embodiment, will be more fully understood from the following specification and drawings, in which:

### DRAWING DESCRIPTION

FIG. 1 is a perspective view of a drum hoop embodying the invention;

FIG. 2 is a plan view of the FIG. 1 hoop;

FIG. 3 is an edge view of the loop;

FIGS. 4 and 5 are enlarged fragmentary sections showing hoop construction;

FIGS. 4b-4c are views showing processing of a hoop strip, prior to hoop formation; and

FIG. 6 shows a complete hoop, in section.

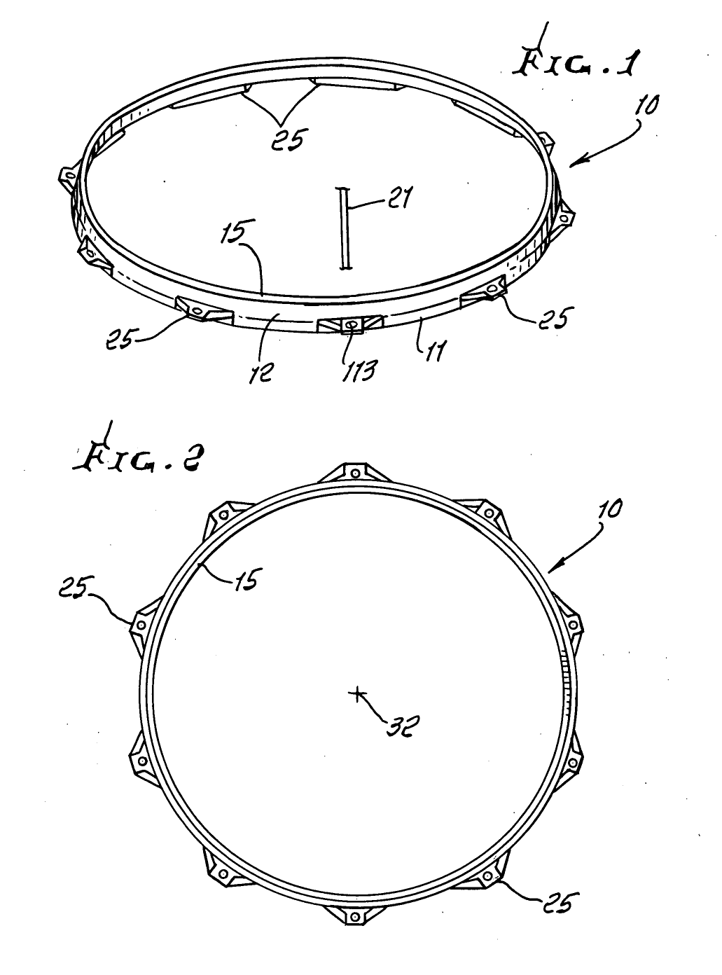

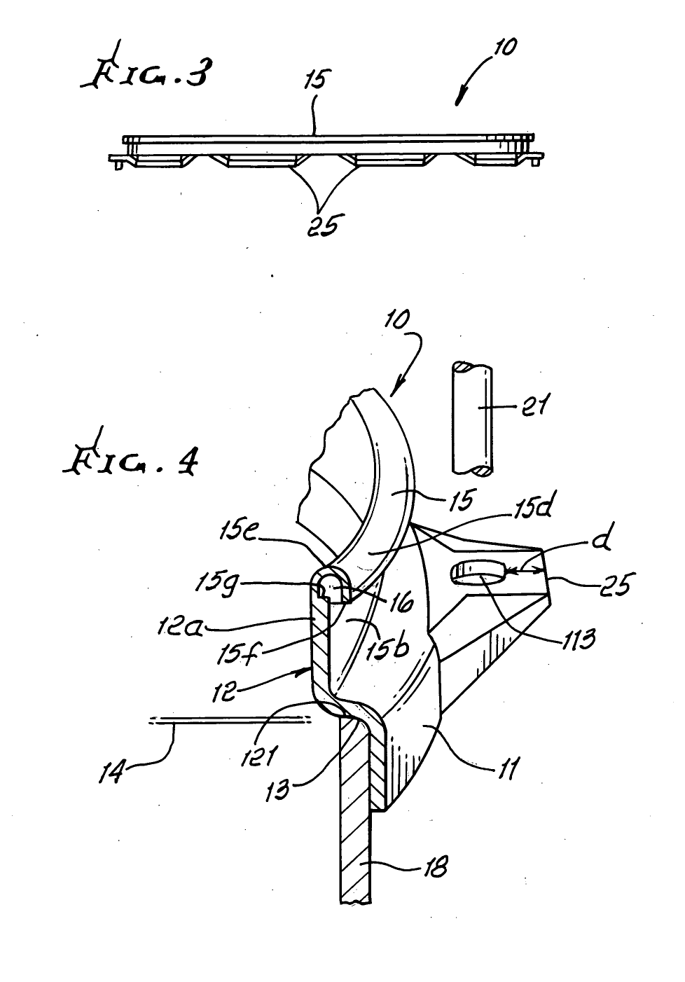

### DETAILED DESCRIPTION

The drum hoop 10 has metallic construction, with walls 11 and 12 offset to receive a drum wall 18 therebetween, i.e. beneath shoulder 13. Wall 12 has an upper edge 15 shaped to resist and prevent damage to a drum stick 17 which may at times impact that edge, during play. Edge 15 is shown, preferably, as rolled toward the outer side of the hoop, and to extend downwardly at 15a. The reduced thickness edge terminal 15c′ faces inwardly toward wall 12, below ledge 15g with a small gap or opening 16 located between 15c′ and wall 12, for water drainage. Outer side of wall 12 is shown at 15b. A typical thickness of wall 11 is about 2 millimeters.

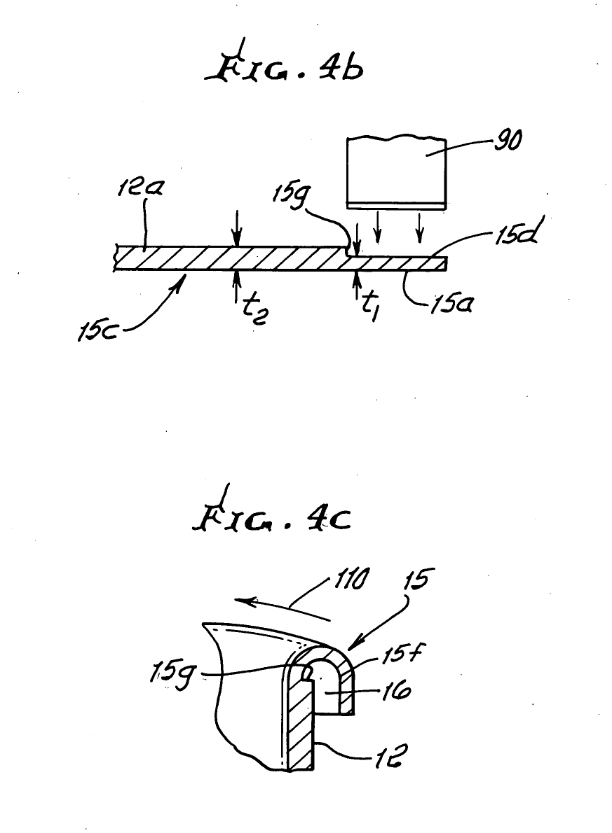

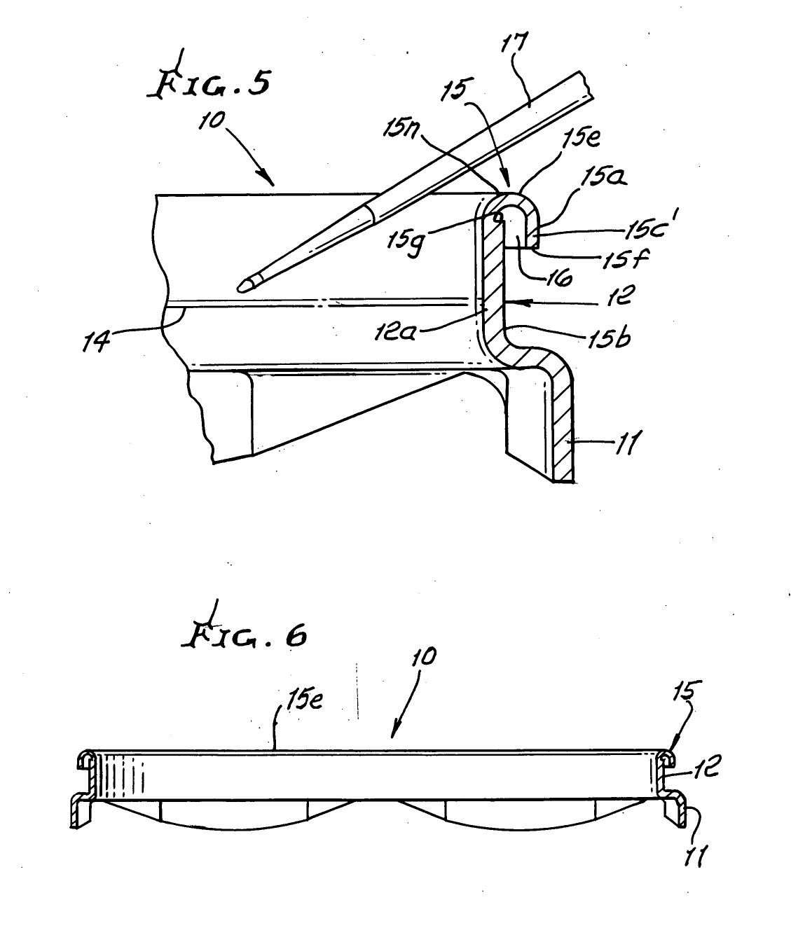

Preferably, the edge portion 15g that is rolled is of substantially reduced thickness at t₁ FIG. 4b, leaving the main extent 12a of wall 12 of relatively un-reduced thickness at t₂, below ledge 15g, in FIGS. 4 and 5. FIG. 4b shows the flat strip of material 15c, and milling tool 90 positioned to remove material at 15d leaving reduced thickness t₁. The length of 15a of reduced thickness between 15f and ledge 15g locates ledge 155. Above the level of terminal 15f. See also FIG. 4c, showing hoop formation bending in direction 110, about the hoop axis with substantially reduced resistance to bending being created due to reduced thickness at 15a, with less hoop distortion during hoop formation.

Location of gap 16, concealed and spaced below upper arcuate surface 15e and below ledge 15g prevents contact of the drum stick 17 with the terminal 15f, and any sharp edge thereof. Also, ledge 15g located as shown enables the approximately 180° rolled metallic extent at 15, 15a and 15n to have substantially reduced thickness relation to wall 11, to facilitate distortion free hoop formation.

A sideward projection 25 from the hoop provides an opening 113 for reception of a tensioning rod 21, in outwardly spaced relation from the gap 16. Space 112 between projection outer edge and through opening 113 that passes the tensioning rod, for tuning is kept constant.

A drum head is seen at 14, and a drum axis at 32. The method of drum distortion free formation includes the following steps:

a) provide flat elongated strip 15c of metal,

b) locally mill a side portion of strip with tool 90 to provide reduced thickness at 15d along an edge portion of strip,

c) deform the elongated strip to provide sideward tuning projections 25 spaced from the reduced thickness edge portion 15a of strip, and also to form a seating edge for engagement with a drum head annular rim 121,

d) roll the reduced thickness edge portion of the elongated strip to thereby form an elongated drum stick engaged or engaging rolled and arcuate edge portion, or bend, as at 15e, that thickness reduction characterized as sufficient to prevent distortion of the hoop out of annularity and to prevent distortion of the tuning projections 25 during such rolling, and hoop bending,

e) and bend the thus formed metal strip into hoop shape, with thickness reduction extending annularly.

Milling the metal strip 15c prior to forming the hoop bend ensures that there are no distortions on the underside, top and bottom of the flanged projections 25, whereby they remain perpendicular to wall 12, and distortion free. Accordingly, the distance “d” from the end of the flanged ear or projections to the edge of the oval hole 113 that passes the tuning rod 114 is consistently the same, at all of the flanged ears 25 around the hoop. The configuration of the channel ledge 120 where the drum head 121 seats, is also consistently the same, around the hoop, whereby tuning of the drum is very simply optimized, and a true hoop configuration is achieved. FIG. 6 shows a completely formed hoop, in section.

I claim:

1. The method of drum structure formation, said structure including a drum shell and a drum head, the method including
a) forming a strip of metal having an elongated edge into a hoop to be supported by the shell proximate the head and having a hoop shaped edge area formed to resist or prevent drum stick damage,
b) said forming including forming a reduced thickness rolled bend proximate said edge area.

2. The method of claim 1, including forming a a gap or opening located between the edge and a side of said strip, said reduced thickness bend presenting a rolled outer surface spaced from said gap, and extending annularly.

3. The method of claim 1, wherein the edge area is blunted.

4. The method of claim 2 wherein the edge area is arcuate.

5. The method of claim 2 wherein said forming of strip reduced thickness is effected prior to said forming of the strip of metal into hoop shape, and prior to said forming of the bend, said reduced thickness sufficient to prevent distortion of the hoop shape during said forming.

6. The method of claim 5 wherein said reduced thickness formation is effected by milling one side of said metal strip, to thereby form a ledge which is spaced at a level above said gap when the hoop shaped edge area extends horizontally.

7. The method of claim 6, wherein the edge area is rolled toward the outer side of the hoop

8. The method of claim 7, wherein the gap or opening is provided at a terminal defined by the rolled edge area, the gap or opening extending circularly about the drum axis along with the rolled edge area.

9. The method of claim 3 wherein the hoop is formed to provide circularly spaced flanges spaced from and in offset relation to the blunted edge area.

10. The combination that includes the formed hoop of claim 1, and having a sideward projection integral with the hoop, and spaced from said rolled edge area, said projection defining an opening for a drum tensioning rod.

11. The combination of claim 10 including said drum shell having an edge supporting said hoop.

12. The combination of claim 10 including a drum head engaging said hoop.

13. The combination of claim 10 including multiple said side projections on and spaced about an axis formed by the hoop, said projections formed to provide through openings of like dimensions.

14. The combination of claim 10 including said drum shell having an edge supporting said hoop at a shoulder defined by the hoop, the hoop having offset upright walls forming a gap, the shoulder extending between said walls in approximate alignment with said hoop edge.

15. The combination of claim 12 wherein the gap or opening is at a terminal defined by the reduced thickness rolled edge, the gap or opening extending circularly about the drum axis.

16. The method of drum structure distortion free formation, that includes steps:
a) provide flat elongated strip of metal,
b) locally mill a side portion of strip to provide reduced thickness along an edge portion of strip,
c) deform the elongated strip to provide sideward tuning projections spaced from the reduced thickness ledge portion of strip, and also to form a seating edge for engagement with a drum head annular rim,
d) roll the reduced thickness edge portion of the elongated strip to thereby form an elongated rolled edge portion, such thickness reduction characterized as sufficient to prevent distortion of said hoop out of annularity and to prevent distortion of said tuning projections during said rolling, and hoop bending,
e) and bend the thus formed metal strip into hoop shape.
